(19) United States
(12) Patent Application Publication
(10) Pub. No.: US 2003/0212771 A1
(43) Pub. Date: Nov. 13, 2003

(54) Method of extending IPv4 address architecture, label switching method using the extended IPv4 address architecture and recording medium for the extended IPv4 address architecture

(76) Inventors: Jeong-gook Kwon, Daejon (KR); In-chae Park, Daejon (KR); Dong-gill Lee, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/234,560

(22) Filed: Sep. 3, 2002

(30) Foreign Application Priority Data
May 7, 2002 (KR) 2002-24993

(51) Int. Cl. G06F 15/177

(52) U.S. Cl. 709/220; 709/238

(57) ABSTRACT

A method of extending an Internet Protocol version 4 (IPv4) address architecture, a method of switching labels using the extended IPv4 address architecture, and a recording medium for recording the extended IPv4 address architecture, are provided. In the IPv4 address architecture extending method, an Internet service provider (ISP) level aggregation label identifier for identifying an ISP is attached to an IPv4 address. A regional-level aggregation label identifier for identifying a region is attached to the IPv4 address to which the ISP-level aggregation label identifier has been attached. A national-level aggregation label identifier for identifying a nation is attached to the IPv4 address to which the ISP-level and regional-level aggregation label identifiers have been attached. According to such a method described above, running out of IPv4 addresses can be solved without changing all application programs on the nodes using conventional IPv4 addresses and installing an extra address transformer. Also, an IPv4 address processing level can design a network using all conventional IPv4 addresses. Thus, network designing is easy.

### BACKGROUND OF THE INVENTION

1. Field of the Invention

The present invention relates to a method of extending an Internet Protocol version 4 (IPv4) address architecture and a method of switching labels using the extended IPv4 address architecture, and more particularly, to a method of extending an IPv4 address architecture by attaching hierarchical label identifiers to a conventional IPv4 address architecture on the Internet, to a method of switching labels using the extended IPv4 address architecture, and to a computer readable recording medium to which the extended IPv4 address architecture has been recorded.

2. Description of the Related Art

An IPv4 address architecture is currently in use for the Internet around the world, and also has been introduced and put into use for the Internet in Korea. In Korea, only official IPv4 addresses are used for the purpose of distinguishing between computers or associated devices connected to the Internet. However, official IPv4 addresses expressed with 32 bits are running out because of an explosive increase in the number of Internet users. In order to solve this problem, IPv6 addresses each composed of 128 bits have been developed and distributed among the Internet users. However, in order to use IPv6 addresses, network-related software and application programs must be updated accordingly.

An IPv4 address architecture is composed of a total of 32 bits, and the IPv4 address architecture assigned to companies, institutions or Internet Server Providers (hereinafter, referred to as ISPs) is divided into a network address identifier and a node address identifier. For an IPv6 address architecture, some of 128 bits are used for a top-level aggregation identifier (TLA ID) field, and the others are used according to the address allocation scheme made by an ISP assigned an IPv6 address.

In multiprotocol label switching (MPLS), a label edge router (LER) and a label switching router (LSR) dynamically allocate labels in flow units of an Internet Protocol (IP) packet and return the label resources after using them.

FIG. 1 shows an IPv4 Internet address architecture 100, which is currently in use. The IPv4 address architecture 100 is composed of a total of 32 bits, and divided into a network address 110 and a node address 120. The length of the network address varies according to the value of a network mask. Internet addresses are classified into 5 address classes, i.e., class A, class B, class C, class D, and class E according to the prefix value of an address, which is the most significant bit of the address. An Internet address is written in the unit of bytes in a one-to-one correspondence to a decimal number.

FIG. 2 shows a general IPv6 address architecture 200, which is composed of a total of 128 bits. Some bits of the IPv6 address architecture 200 are used for a TLA ID field 210, and the remaining bits are used according to the address allocation scheme made by an ISP assigned an IPv6 address. That is, the IPv6 address architecture 200 further includes a next-level aggregation identifier (NLA ID) field 220, a site-level aggregation (SLA) ID field 230 and an interface ID field 240. The interface ID 240 can be replaced by the IPv4 address structure 100.

FIG. 3 shows a header 300 for MPLS label information. The header 300 includes a label field 310 and an experimental field 320, both of which are used for high-speed packet switching on the core network, a stacking field 330 indicating label storage and a time to live (TTL) field 340 representing the life time of a packet.

As described above, the Internet uses IPv4 and IPv6 addresses and MPLS label information. The IPv4 addresses are expressed in an integer number, the IPv6 addresses are expressed in a hexadecimal number, and the MPLS network expresses label information in a binary number.

An IPv6 address architecture, which is an extended version of a conventional IPv4 address architecture, has a drawback that conventional application programs must be changed according to the use of IPv6 addresses. A label switching method using the conventional IPv4 address architecture requires a label router to maintain a lot of labels, thus causing an increase in packet transmission time.

### SUMMARY OF THE INVENTION

To solve the above-described problems, it is an object of the present invention to provide a method of extending an IPv4 address architecture in order to overcome running out of IPv4 addresses without changing all application programs on the nodes that use the IPv4 addresses.

Another object of the present invention is to provide a label switching method using an extended IPv4 address architecture capable of diminishing a label information table for use on a label switching network and reducing the packet transmission time.

Still another object of the present invention is to provide a recording medium to which the extended IPv4 address architecture has been recorded, and a computer readable recording medium to which an Internet message header architecture for the extended IPv4 address architecture has been recorded.

The first object of the present invention is achieved by a method of extending an Internet Protocol version 4 (IPv4) address architecture. In this method, an Internet service provider (ISP) level aggregation label identifier for identifying an ISP is attached to an IPv4 address. A regional-level aggregation label identifier for identifying a region is attached to the IPv4 address to which the ISP-level aggregation label identifier has been attached. A national-level aggregation label identifier for identifying a nation is attached to the IPv4 address to which the ISP-level and regional-level aggregation label identifiers have been attached.

Preferably, a top-level aggregation (TLA) label identifier for identifying a general packet, a unicast packet or a multicast packet is further attached to the IPv4 address to which the ISP-level, regional-level and national-level aggregation label identifiers have been attached.

Preferably, each of the ISP-level, regional-level and national-level aggregation label identifiers is composed of 16 bits.

It is preferable that each of the ISP-level, regional-level and national-level aggregation label identifiers is expressed as a dotted hexadecimal number with 2 bytes.

Preferably, the ISP-level, regional-level and national-level aggregation label identifiers are attached to the front of the IPv4 address for a host name in the A-type resource record entry of a domain name server (DNS).

The first object of the present invention is also achieved by a method of extending an IPv4 address architecture, in which an extended IPv4 address architecture is distinguished from a conventional IPv4 address architecture, using the type of service (TOS) field of an IPv4 datagram header, and a hierarchical destination label identifier and a hierarchical source label identifier are attached to the rear of the IPv4 datagram header.

Preferably, an extended IPv4 address architecture obtained by the above-described method is used at an IPv4 address processing level and label processing levels.

It is also preferable that an extended IPv4 address architecture is distinguished from a conventional IPv4 address architecture by a precedence field composed of 3 most significant bits among the bits of the TOS field.

Preferably, the hierarchical destination and source label identifiers are attached to the option field of the IPv4 datagram header.

It is preferable that each of the hierarchical destination and source label identifiers includes a top-level aggregation label identifier for identifying a general packet, a unicast packet or a multicast packet, a national-level aggregation label identifier for identifying a nation, a regional-level aggregation label identifier for identifying a region, and an ISP-level aggregation label identifier for identifying an ISP.

Preferably, the hierarchical destination label identifier and the hierarchical source label identifier are attached to the front of the IPv4 datagram header. An extended IPv4 address architecture obtained by the above-described method is used at an IPv4 address processing level and label processing levels.

The second object of the present invention is achieved by a method of hierarchically switching labels using an extended IPv4 address architecture in which a national-level aggregation label identifier for identifying a nation, a regional-level aggregation label identifier for identifying a region, and an ISP-level aggregation label identifier for identifying an ISP are attached to an IPv4 address. A router in a national-level aggregation label processing level checks the national-level and regional-level aggregation label identifiers and transfers a message to an agreed destination. A router in a regional-level label processing level checks the national-level, regional-level and ISP-level aggregation label identifiers and transfers the message to an agreed destination. A router in an ISP-level label processing level checks the national-level, regional-level and ISP-level aggregation label identifiers and the IPv4 address and transfers the message to an agreed destination. A router in an IPv4 address processing level separately checks a conventional IPv4 address and an extended IPv4 address and transfers the message to an agreed destination.

The third object of the present invention is achieved by a computer readable recording medium for recording an extended IPv4 address architecture composed of a top-level aggregation label identifier for identifying a general packet, a unicast packet or a multicast packet, a national-level aggregation label identifier for identifying a nation, a regional-level aggregation label identifier for identifying a region, and an ISP-level aggregation label identifier for identifying an ISP.

The third object of the present invention is also achieved by a computer readable recording medium for recording an Internet message header architecture for use in an extended IPv4 address architecture. The Internet message header architecture includes an IPv4 message header including the TOS field of an IPv4 datagram header to distinguish a conventional IPv4 address from an extended IPv4 address. The Internet message header architecture also includes the following label identifiers; a top-level aggregation label identifier for identifying a general packet, a unicast packet or a multicast packet, a national-level aggregation label identifier for identifying a destination nation, a regional-level aggregation label identifier for identifying a destination region, an ISP-level aggregation label identifier for identifying a destination ISP, a national-level aggregation label identifier for identifying a source nation, a regional-level aggregation label identifier for identifying a source region, and an ISP-level aggregation label identifier for identifying a source ISP.

### BRIEF DESCRIPTION OF THE DRAWINGS

The above objects and advantages of the present invention will become more apparent by describing in detail preferred embodiments thereof with reference to the attached drawings in which:

FIG. 1 shows a conventional Internet Protocol version 4 (IPv4) address architecture;

FIG. 2 shows a conventional IPv6 address architecture;

FIG. 3 shows a header architecture for a conventional multiprotocol label switching (MPLS) message;

FIG. 4 shows an Internet address architecture obtained by attaching hierarchically fixed label identifiers to an IPv4 address to serve as the prefix of the IPv4 address, according to the present invention;

FIG. 5 shows an IPv4 header architecture obtained by applying a hierarchically fixed label identifier for the option field of an IPv4 message header, according to the present invention;

FIG. 6 shows an IPv4 header architecture obtained by applying a hierarchically fixed label identifier for the prefix of an IPv4 message header, according to the present invention;

FIG. 7 shows extended IPv4 address fields included in the resource record entry of a domain name server (DNS);

FIG. 8 is a symbolic diagram showing the levels of a network using a prefix HIPv4 address architecture and a postfix HIPv4 address; and

FIG. 9 is a symbolic diagram illustrating a hierarchical label switching method when routing a packet in an address architecture according to the present invention, which is obtained by applying a hierarchically fixed label identifier to an IPv4 address architecture.

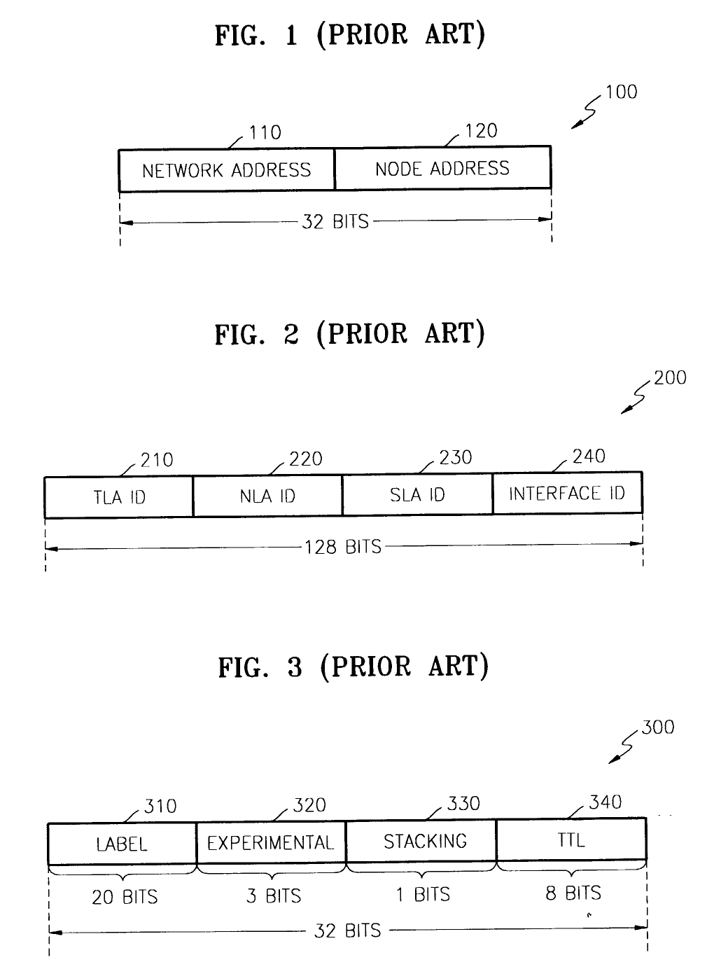

### DETAILED DESCRIPTION OF THE INVENTION

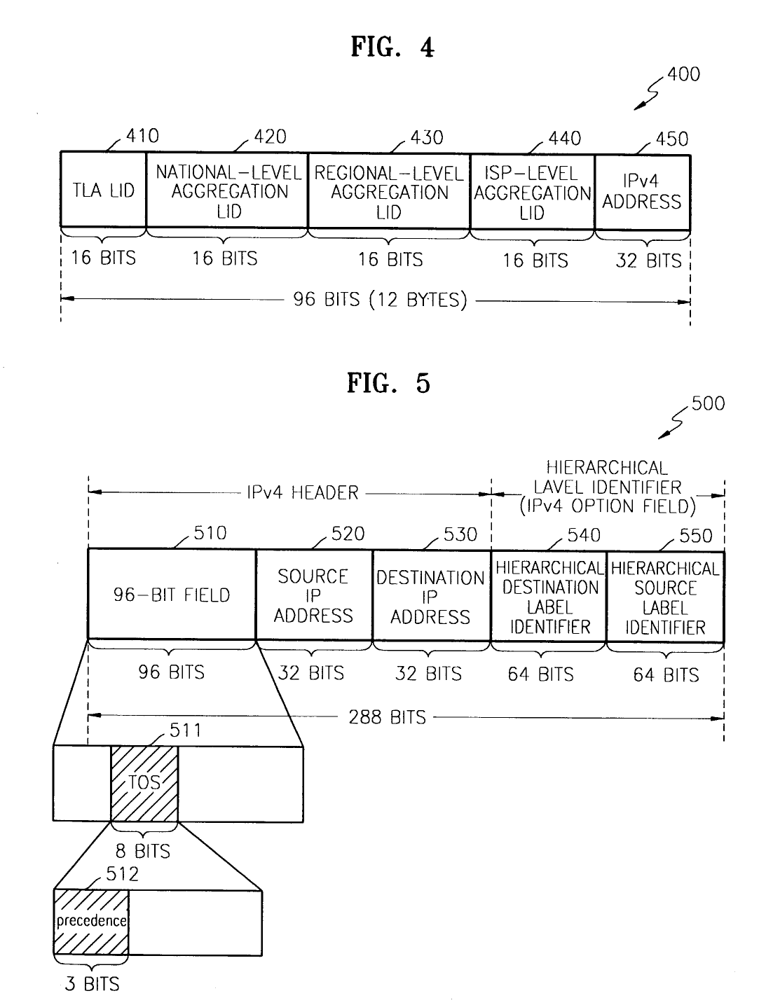

FIG. 4 shows a hybrid Internet Protocol version 4 (HIPv4) address architecture 400 according to the present invention, which is composed of 96 bits. The HIPv4 address architecture 400 includes a total of 5 fields: a top-level aggregation label identifier (TLA LID) 410, a national-level aggregation LID 420, a regional-level aggregation LID 430, an Internet service provider (ISP) level LID 440 and an IPv4 address 450.

The HIPv4 address architecture 400 is expressed as a binary number with 12 bytes and is applied to communications.

The TLA LID 410 is not used for general address writing but used to distinguish between a general packet, a unicast packet and a multicast packet, which are used on the Internet.

A HIPv4 address is written with 10 bytes excluding the TLA LID 410. A label field and an IPv4 address field are separated by a symbol “:”. The label field is specified in dotted hexadecimal notation by separating every two bytes for each level using a decimal point. The IPv4 address field is conventionally specified in dotted decimal notation by separating one byte by one byte using a dot. For example, a HIPv4 address can be written as “0001.0002.0003:129.254.9.3”.

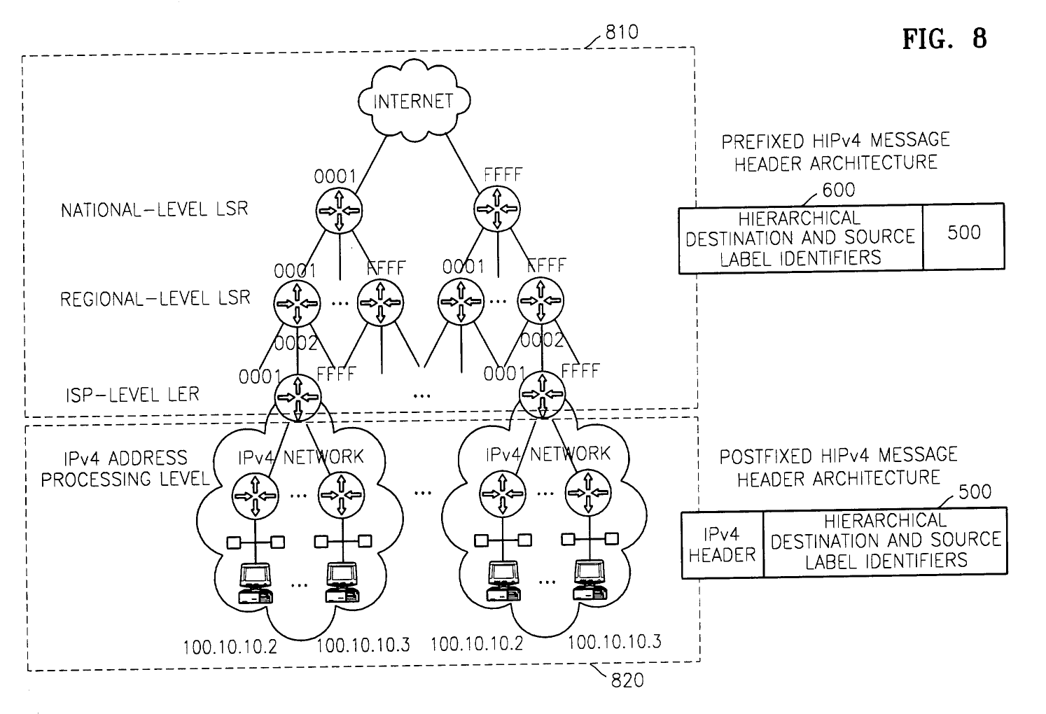

When a packet is transmitted in the HIPv4 address architecture according to the present invention, hierarchical label identifiers are checked and labels are hierarchically switched according to the value of a label identifier checked. As shown in FIG. 8, an IPv4 address processing level 820 or its lower levels uses a postfixed HIPv4 message header architecture 500 in which hierarchical destination and source label identifiers are applied to the option field of a conventional IPv4 message header. A label identifier processing level 810, which is hierarchically above the IPv4 address processing level 820, uses a prefixed HIPv4 message header architecture 600 in which hierarchical destination and source label identifiers are attached to the front of the postfixed HIPv4 message header architecture 500.

FIG. 5 shows the postfixed HIPv4 message header architecture 500 in which a hierarchical label identifier is applied to the option field of a conventional IPv4 message header in the IPv4 address processing level and its lower levels for establishing communications. The architecture 500 is composed of a total of 288 bits and includes a 96-bit field 510, a source IP address field 520, a destination IP address field 530, a hierarchical destination label identifier 540, and a hierarchical source label identifier 550.

In the IPv4 address processing level, an IPv4 message and a postfixed HIPv4 message are distinguished from each other using a precedence field 512, which are the 3 upper bits of a type of service field 511 among the 96 bits of the IPv4 header. That is, if the precedence field 512 represents a value of 100, its header is identified as a postfixed HIPv4 header, and otherwise, its header is identified as a general IPv4 header.

The router for the IPv4 address processing level distinguishes between an IPv4 node and a HIPv4 node using the flag bit of a routing entry as an index, and transfers a packet. That is, the router for the IPv4 address processing level sets the flag of the routing entry for the HIPv4 node, and uses the IPv4 node as packet destination identification information in the same manner as in the prior art.

Each of the hierarchical destination and source label identifiers 540 and 550 is composed of the TLA LID 410, the national-level aggregation LID 420, the regional-level aggregation LID 430, and the ISP level LID 440, which are shown in FIG. 4. The identifiers 540 and 550 are placed in an IPv4 option field.

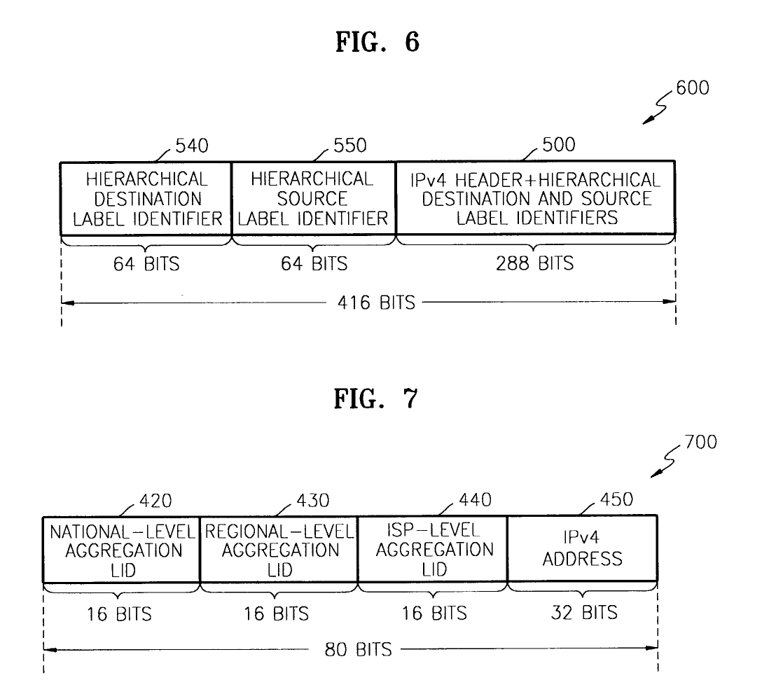

FIG. 6 shows the prefixed HIPv4 header architecture 600, which is processed by the label switching router (LSR) and the label edge router (LER) in the label identifier processing level 810, that is, on the label switching core network. The prefixed HIPv4 header architecture 600 has the format in which the hierarchical destination label identifier 540 and the hierarchical source label identifier 550 are attached to the front of the postfixed HIPv4 message header architecture 500 of FIG. 5. Accordingly, the prefixed HIPv4 header architecture 600 is composed of 416 bits and has three fields.

Each of the hierarchical destination and source label identifiers 540 and 550 is composed of the TLA LID 410, the national-level aggregation LID 420, the regional-level aggregation LID 430, and the ISP-level LID 440, which are shown in FIG. 4.

The prefixed HIPv4 header architecture 600 is provided apart from the postfixed HIPv4 header architecture 500 because, when each of the routers within a label switching network uses such a postfixed HIPv4 header architecture as shown in FIG. 5 upon label switching, a hierarchical destination label identifier is not read until the IPv4 header is read, which causes a time delay. However, for a prefixed HIPv4 header architecture as shown in FIG. 6, in which a hierarchical destination label identifier is placed at the head of a header architecture, the time delay likely to be generated because of the header architecture of FIG. 5 can be prevented.

In addition, a domain name server (DNS) provides a HIPv4 address architecture by extending an existing DNS function.

DNSs establishing DNS decentralized database store resource records for mapping host names to IP addresses. Each of the DNSs replies with a message having at least one resource record. A resource record has a domain name field, a value field, a type field and a time-to-live (TTL) field. The type of resource records includes A, NS, CNAME, MX, etc. The name field for an A resource record provides a host name, and the value field for the A resource record holds an IP address for the host name.

FIG. 7 shows an address architecture 700 in which a HIPv4 address architecture is applied to the A-type address resource record entry of a DNS. The address architecture 700 is composed of 80 bits and includes four fields: the national-level aggregation LID 420, the regional-level aggregation LID 430, the ISP-level aggregation LID 440 and the IPv4 address 450. A DNS for a HIPv4 address architecture provides a HIPv4 address architecture by extending the address resource recording function of an existing IPv4 DNS. In other words, hierarchically fixed label identifiers are attached to the front of an IPv4 address. When a DNS receives a query message for the name of a destination host from a source host, it can send a reply giving an IP address in which hierarchically-fixed label identifiers are attached to an IPv4 address as shown in FIG. 7.

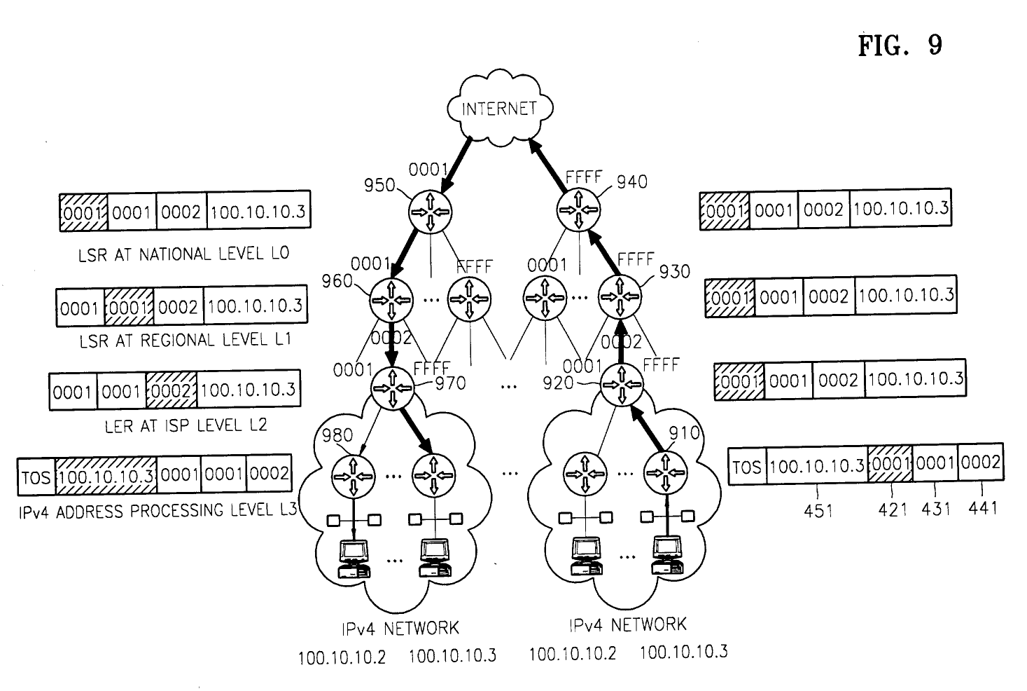

FIG. 9 illustrates a hierarchical label switching process using hierarchically fixed label identifiers when a packet is transmitted in an HIPv4 address architecture of the present invention, and processing of an IPv4 address in an IPv4 address processing level, which is lower than the ISP label processing level.

In a source host, the IPv4 address connected to a router 910 is 100.10.10.3. In a destination host, the IPv4 address connected to a router 980 is also 100.10.10.3. Accordingly, when the address of the source host has a national-level aggregation LID of FFFF, a regional-level aggregation LID of FFFF, an ISP-level aggregation LID of 0002 and the IPv4 address of 100.10.10.3, an HIPv4 address architecture of the present invention can be written as “FFFF.FFFF.0002:100.10.10.3”. When the address of the destination host has a national-level aggregation LID of 0001, a regional-level aggregation LID of 0001, an ISP-level aggregation LID of 0002 and the IPv4 address of 100.10.10.3, an HIPv4 address architecture of the present invention can be written as “0001.0001.0002:100.10.10.3”. In FIG. 9, only the HIPv4 address architecture for the destination host is shown.

In order to transfer a packet from the source host to the destination host, first of all, the source host obtains the HIPv4 address (421+431+441+451) for the destination host using an extended DNS providing a HIPv4 address architecture of the present invention. Since the national-level aggregation LID 421 in the destination host address is 0001, the hosts and routers having a national-level aggregation LID of FFFF transfer a message up to an LSR 940 at a national-level label processing level L0. Thereafter, the LSR 940 transfers the message to an LSR/LER 950 having an NLA LID of 0001.

The LSR/LER 950 at the national-level label processing level L0, which is the top level, searches the national-level aggregation LID of 0001 and the regional-level aggregation LID of 0001 and transfers the message to an LSR/LER 960 corresponding to an agreed destination. The LSR/LER 960 at a regional-level label processing level L1 searches the national-level aggregation LID of 0001, the regional-level aggregation LID of 0001 and an ISP-level aggregation LID of 0002 and transfers the message to an LSR/LER 970 being an agreed destination. The LSR/LER 970 at an ISP-level label processing level L2 searches the regional-level aggregation LID of 0001, the ISP-level aggregation LID of 0002 and the IPv4 address of 100.10.10.3 and transfers the message to an LSR/LER 980 being an agreed destination. The LSR/LER 980 in an IPv4 address processing level L3 searches the national-level, regional-level and ISP-level aggregation LIDs and IPv4 address of 100.10.10.3 included in the HIPv4 address, and transfers the message to an agreed destination host. Meanwhile, the LSR in each of the levels L0 through L3 transfers a packet whose destination address cannot be known back to the LSR at its upper level.

As described above referring to FIG. 8, the label processing levels L0, L1 and L2 use a prefixed HIPv4 address architecture, and the IPv4 address processing level L3 uses a postfixed HIPv4 address architecture.

The Internet address architecture according to the present invention can be written as a computer readable code in a computer readable recording medium. The computer readable recording medium includes all types of recording devices for storing computer readable data, for example, ROMs, RAMs, CD-ROMs, magnetic tapes, floppy discs, and optical data storage devices. In particular, the Internet address architecture according to the present invention can be transmitted via a carrier wave such as Internet. Also, the computer readable recording medium can store and execute computer readable codes in a decentralized manner since it is decentralized to a computer system to which the recording medium is connected via a network.

In such an extended IPv4 address architecture using hierarchically fixed label identifiers according to the present invention as described above, running out of IPv4 addresses can be solved without changing all application programs on nodes using conventional IPv4 addresses and installing an extra address transformer. Also, an IPv4 address processing level can design a network using all of 4.2 billion conventional independent IPv4 addresses. Thus, network designing is easy.

In a label switching method using the extended IPv4 address architecture of the present invention, the LSR/LER at each level can reduce the size of a label information table, and improve the switching performance because destinations are distinguished from each other using only the national-level, regional-level and ISO-level LIDs. In addition, a packet can be transferred at a wire speed.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A method of extending an Internet Protocol version 4 (IPv4) address architecture, the method comprising:
attaching an Internet service provider (ISP) level aggregation label identifier for identifying an ISP to an IPv4 address;
attaching a regional-level aggregation label identifier for identifying a region to the IPv4 address to which the ISP-level aggregation label identifier has been attached; and
attaching a national-level aggregation label identifier for identifying a nation to the IPv4 address to which the ISP-level and regional-level aggregation label identifiers have been attached.

2. The method of claim, further comprising attaching a top-level aggregation (TLA) label identifier for identifying a general packet, a unicast packet or a multicast packet to the IPv4 address to which the ISP-level, regional-level and national-level aggregation label identifiers have been attached.

3. The method of claim 1, wherein each of the ISP-level, regional-level and national-level aggregation label identifiers is composed of 16 bits.

4. The method of claim 1, wherein each of the ISP-level, regional-level and national-level aggregation label identifiers is composed of 2 bytes written in a dotted hexadecimal notation.

5. The method of claim 1, further comprising attaching the ISP-level, regional-level and national-level aggregation label identifiers to the front of the IPv4 address for a host name in the A-type resource record entry of a domain name server (DNS).

6. A method of extending an IPv4 address architecture, the method comprising:
distinguishing an extended IPv4 address architecture from a conventional IPv4 address architecture, using the type of service (TOS) field of an IPv4 datagram header; and
attaching a hierarchical destination label identifier and a hierarchical source label identifier to the rear of the IPv4 datagram header.

7. The method of claim 6, wherein an extended IPv4 address architecture is distinguished from a conventional IPv4 address architecture by a precedence field composed of 3 most significant bits among the bits of the TOS field.

8. The method of claim 6, wherein the hierarchical destination and source label identifiers are attached to the option field of the IPv4 datagram header.

9. The method of claim 6, wherein each of the hierarchical destination and source label identifiers includes a top-level aggregation label identifier for identifying a general packet, a unicast packet or a multicast packet, a national-level aggregation label identifier for identifying a nation, a regional-level aggregation label identifier for identifying a region, and an ISP-level aggregation label identifier for identifying an ISP.

10. The method of claim 6, wherein an extended IPv4 address architecture obtained by the method of claim 6 is used at an IPv4 address processing level.

11. The method of claim 6, further comprising attaching the hierarchical destination label identifier and the hierarchical source label identifier to the front of the IPv4 datagram header.

12. The method of claim 11, wherein an extended IPv4 address architecture obtained by the method of claim 11 is used at the IPv4 address processing level.

13. A method of hierarchically switching labels using an extended IPv4 address architecture, the method comprising:
providing an extended IPv4 address architecture in which a national-level aggregation label identifier for identifying a nation, a regional-level aggregation label identifier for identifying a region, and an ISP-level aggregation label identifier for identifying an ISP are attached to an IPv4 address;
checking the national-level and regional-level aggregation label identifiers and transferring a message to an agreed destination by a router in a national-level aggregation label processing level;
checking the national-level, regional-level and ISP-level aggregation label identifiers and transferring a message to an agreed destination by a router in a regional-level label processing level;
checking the national-level, regional-level and ISP-level aggregation label identifiers and the IPv4 address and transferring a message to an agreed destination by a router in an ISP-level label processing level; and
separately checking a conventional IPv4 address and an extended IPv4 address and transferring the message to an agreed destination by a router in an IPv4 address processing level.

14. A computer readable recording medium for recording an extended IPv4 address architecture comprising:
a top-level aggregation label identifier for identifying a general packet, a unicast packet or a multicast packet;
a national-level aggregation label identifier for identifying a nation;
a regional-level aggregation label identifier for identifying a region; and
an ISP-level aggregation label identifier for identifying an ISP.

15. A computer readable recording medium for recording an Internet message header architecture for use in an extended IPv4 address architecture, the Internet message header architecture comprising:
an IPv4 message header including the TOS field of an IPv4 datagram header to distinguish a conventional IPv4 address from an extended IPv4 address;
a top-level aggregation label identifier for identifying a general packet, a unicast packet or a multicast packet;
a national-level aggregation label identifier for identifying a destination nation;
a regional-level aggregation label identifier for identifying a destination region;
an ISP-level aggregation label identifier for identifying a destination ISP;
a national-level aggregation label identifier for identifying a source nation;
a regional-level aggregation label identifier for identifying a source region; and
an ISP-level aggregation label identifier for identifying a source ISP.
